(19) United States
(12) Patent Application Publication
(10) Pub. No.: US 2018/0314229 A1
(43) Pub. Date: Nov. 1, 2018

(54) System and Method for Analytics based Integration of Internet of Things Asset Design with Asset Operation

(71) Applicant: International Business Machines Corporation, Armonk, NY (US)

(72) Inventors: Ana C. BIAZETTI, Cary, NC (US); Alexis DA ROCHA SILVA, SÃO PAULO (BR)

(21) Appl. No.: 15/499,012

(22) Filed: Apr. 27, 2017

(51) Int. Cl. G05B 19/408; G06N 5/02

(52) U.S. Cl. CPC G05B 19/408; G05B 2219/31396; G06N 5/022

(57) ABSTRACT

A system integrates an asset design system with an asset operation system. The system maps a first asset design created in the asset design system, to the asset operation system. Using a design analyzer that interfaces with an operational assets database, the system maps the first asset design to a first operational model in the operational assets database in the asset operation system. The system uses predictive analytics techniques to map the first asset design to the first operational model. The system maps a second operation model to the asset design system. Using an operation analyzer that interfaces with a maintenance history database in the asset operation system, the system maps the second operation model to a second asset design in the asset design system. The system provides suggested design changes to the second asset design based on data in the maintenance history database.

### BACKGROUND

In regulated industries with complex Internet of Things (IoT) Assets (such as transportation, aerospace and defense, nuclear, life sciences, etc.) management of asset configuration, component life accounting, and equipment operational status is critical to the success of an operation. With complex IoT assets, there may be many assets, each with many components to manage. The design and maintenance of IoT assets are often disconnected and disjointed, causing issues in the assets lifecycle. There exists a need to tightly control changes in component design, and component maintenance. There is also a need to tightly control component use that can affect the design. Changes made by a design team are not automatically reflected in existent operations, and changes performed in operations are not generally used to improve designs. Therefore, it would be helpful to integrate IoT asset design with asset operation.

### SUMMARY

According to an embodiment of the present invention, in a method for integrating an asset design system with an asset operation system, the method maps a first asset design created in the asset design system to the asset operation system. Using a design analyzer that interfaces with an operational assets database, the method maps the first asset design to a first operational model in the operational assets database in the asset operation system.

In an example embodiment, when the method uses the design analyzer, the method uses predictive analytics techniques to map the first asset design to the first operational model.

In an example embodiment, when the method uses the design analyzer, the design analyzer analyzes an asset designs database to identify asset designs that are similar to the first asset design. The design analyzer ranks the identified asset designs to determine preferred asset designs. The design analyzer determines whether there are asset models in the operational assets database that match the preferred asset designs. The design analyzer identifies asset models in the operational assets database that match the preferred asset designs. The design analyzer proposes reusing at least one of the asset models to create the first operational model by modifying at least one of the asset models to match the first asset design. The method creates the first operational model from at least one modified asset models. The method then stores the first operational model in the operational assets database with a design object key linking the first operational model to the first asset design. In an example embodiment, if the design analyzer fails to identify asset models in the operational assets database that match the preferred asset designs, the design analyzer analyzes model templates in a model templates database in the asset operation system that match the preferred asset designs. The model templates are used to create operational models. The design analyzer proposes using at least one of the model templates to create the first operational model. The method creates the first operational model from at least one of the model templates. The method then stores the first operational model in the operational assets database with a design object key linking the first operational model to the first asset design.

In an example embodiment, when the design analyzer analyzes the asset designs database to identify asset designs that are similar to the first asset design comprises, the design analyzer analyzes components associated with each of the asset designs where each of the asset designs is comprised of a respective plurality of components. The design analyzer identifies asset designs in which the respective plurality of components meets a similarity threshold with first asset design components, where the first asset design is comprised of the first asset design components.

In an example embodiment, the method maps a second operation model to the asset design system by mapping, using an operation analyzer that interfaces with a maintenance history database in the asset operation system, the second operation model to a second asset design in the asset design system. The operation analyzer provides suggested design changes to the second asset design based on data in the maintenance history database.

In an example embodiment, when the operation analyzer provides suggested design changes to the second asset design based on data in the maintenance history database, the operation analyzer detects anomalies from the data in the maintenance history database that indicate the second operation model has a high failure rate. The operation analyzer identifies at least one failing component with failure data that exceeds a failure threshold. The second operation model comprises at least one failing component. The operation analyzer uses predictive analytics techniques to recommend design changes to the second operation model.

In an example embodiment, when the operation analyzer uses predictive analytics techniques to recommend design changes to the second operation model, the operation analyzer identifies, from the maintenance history database, at least one component that at least meets a low failure threshold, where at least one component is similar to at least one failing component. The operation analyzer recommends at least one of (i) use of at least one component in the second operation model to reduce the high failure rate associated with the second operation model, and (ii) modification of at least one failing component using at least one component as a prototype, to reduce the high failure rate associated with the second operation model.

In an example embodiment, when the operation analyzer uses predictive analytics techniques to recommend design changes to the second operation model, the method automatically implements the recommended design changes, and/or transmits the recommended design changes to a user, and automatically implements the recommended design changes upon approval from the user.

In an example embodiment, when the operation analyzer uses predictive analytics techniques to recommend design changes to the second operation model, the method obtains, from the operational assets database, a design object key associated with the second operation model. The method uses the design object key associated with the second operation model to locate the second asset design in the asset design system. The method implements the recommended design change for the second asset design in the asset design system.

### BRIEF DESCRIPTION OF THE DRAWINGS

FIG. 1 illustrates an embodiment of a system for integrating an asset design system with an asset operation system, according to embodiments disclosed herein.

FIG. 2 illustrates an example high level system for integrating an asset design system with an asset operation system, according to embodiments disclosed herein.

FIG. 3 is a flowchart illustrating an embodiment of a method for integrating an asset design system with an asset operation system, according to embodiments disclosed herein.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

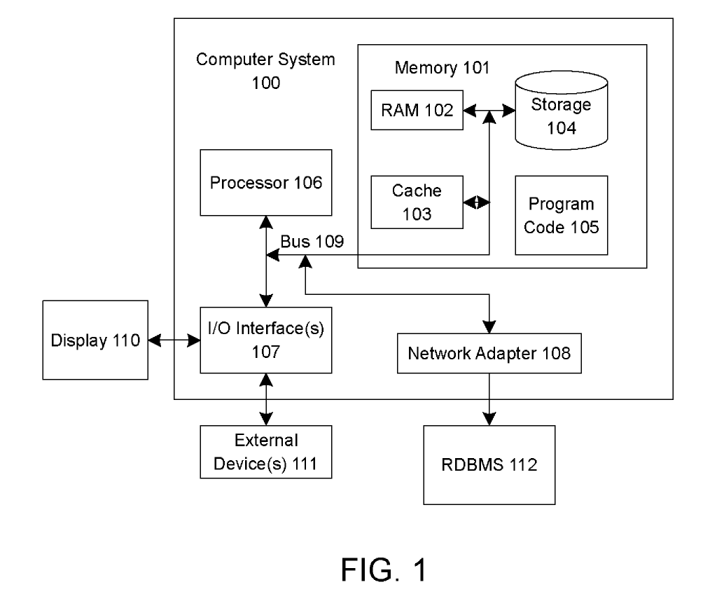

FIG. 1 illustrates a system for integrating an asset design system with an asset operation system according to embodiments disclosed herein. The computer system 100 is operationally coupled to a processor or processing units 106, a memory 101, and a bus 109 that couples various system components, including the memory 101 to the processor 106. The bus 109 represents one or more of any of several types of bus structure, including a memory bus or memory controller, a peripheral bus, an accelerated graphics port, and a processor or local bus using any of a variety of bus architectures. The memory 101 may include computer readable media in the form of volatile memory, such as random access memory (RAM) 102 or cache memory 103, or non-volatile storage media 104. The memory 101 may include at least one program product having a set of at least one program code module 105 that are configured to carry out the functions of embodiments of the present invention when executed by the processor 106. The computer system 100 may also communicate with one or more external devices 111, such as a display 110, via I/O interfaces 107. The computer system 100 may communicate with one or more networks via network adapter 108. The computer system 100 may communicate with one or more databases 112 via network adapter 108.

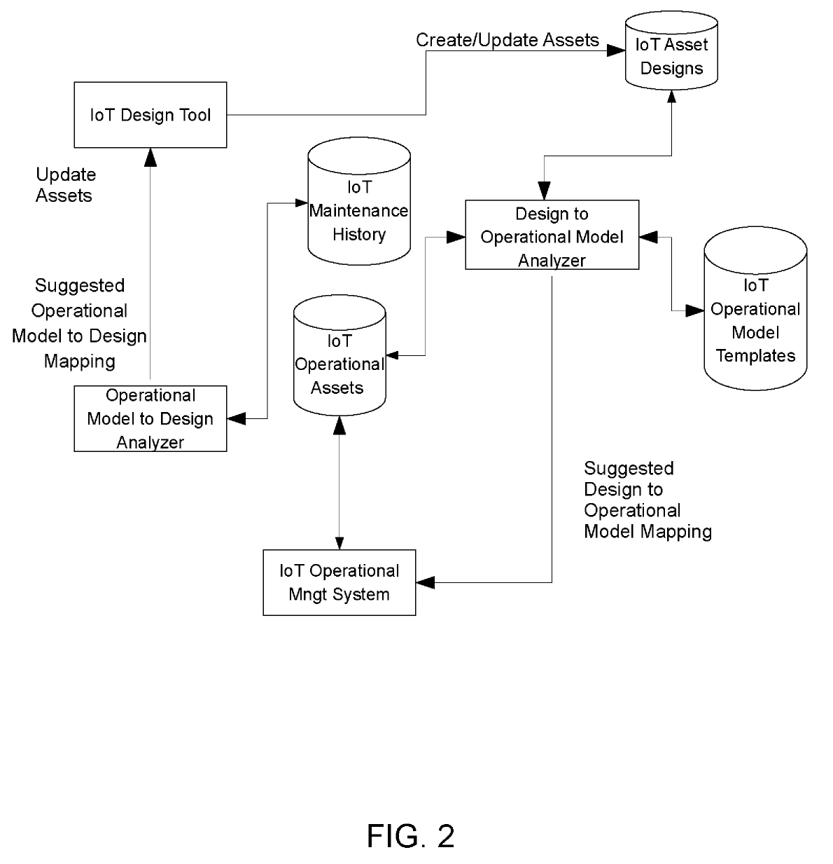

FIG. 2 illustrates an example high level system for integrating an asset design system with an asset operation system. In an example embodiment, the method maps a first asset design created in the asset design system (for example, using the IoT Design Tool) to the asset operation system (i.e., the IoT Operational Mngt System) by mapping, using a design analyzer (i.e., the Design to Operational Model Analyzer) that interfaces with an operational assets database (i.e., the IoT Operational Assets), the first asset design to a first operational model in the operational assets database in the asset operation system. The design analyzer analyzes an asset designs database (i.e., Iot Asset Designs) to identify asset designs that are similar to the first asset design, and ranks the identified asset designs to determine preferred asset designs. The design analyzer determines whether there are asset models in the operational assets database that match the preferred asset designs. In an example embodiment, the method modifies one of the asset models to create the first operational model, and stores the first operational model in the operational assets database with a design object key linking the first operational model to the first asset design. If the design analyzer fails to identify asset models in the operational assets database that match the preferred asset designs, the design analyzer analyzes model templates in a model templates database (i.e., IoT Operational Model Templates) in the asset operation system that match the preferred asset designs, and proposes using one of the model templates to create the first operational model. The method then creates the first operational model from the model template, and stores the first operational model in the operational assets database with a design object key linking the first operational model to the first asset design. In an example embodiment, a user approves the proposed model template (with any modification that may be needed to the model template) prior to the method creating the first operational model from the model template.

In an example embodiment, an operation analyzer (i.e., Operational Model to Design Analyzer) that interfaces with a maintenance history database (i.e., IoT Maintenance History) in the asset operation system, maps a second operation model to the asset design system by mapping the second operation model to a second asset design in the asset design system. The operation analyzer provides suggested design changes to the second asset design based on data in the maintenance history database. The operation analyzer detects anomalies from the data in the maintenance history database that indicate the second operation model has a high failure rate, and identifies at least one failing component with failure data that exceeds a failure threshold, where the second operation model comprises the failing component. The operation analyzer uses predictive analytics techniques to recommend design changes to the second operation model. The operation analyzer identifies, from the maintenance history database, at least one component that, at the very least, meets a low failure threshold, where the component is similar to the failing component(s). The operation analyzer recommends using the component in the second operation model to reduce the high failure rate associated with the second operation model, and/or modifying the failing component using the component as a prototype to reduce the high failure rate associated with the second operation model. In an example embodiment, the method obtains, from the operational assets database, a design object key associated with the second operation model, and uses the design object key associated with the second operation model to locate the second asset design in the asset design system. The method then implements the recommended design change for the second asset design in the asset design system.

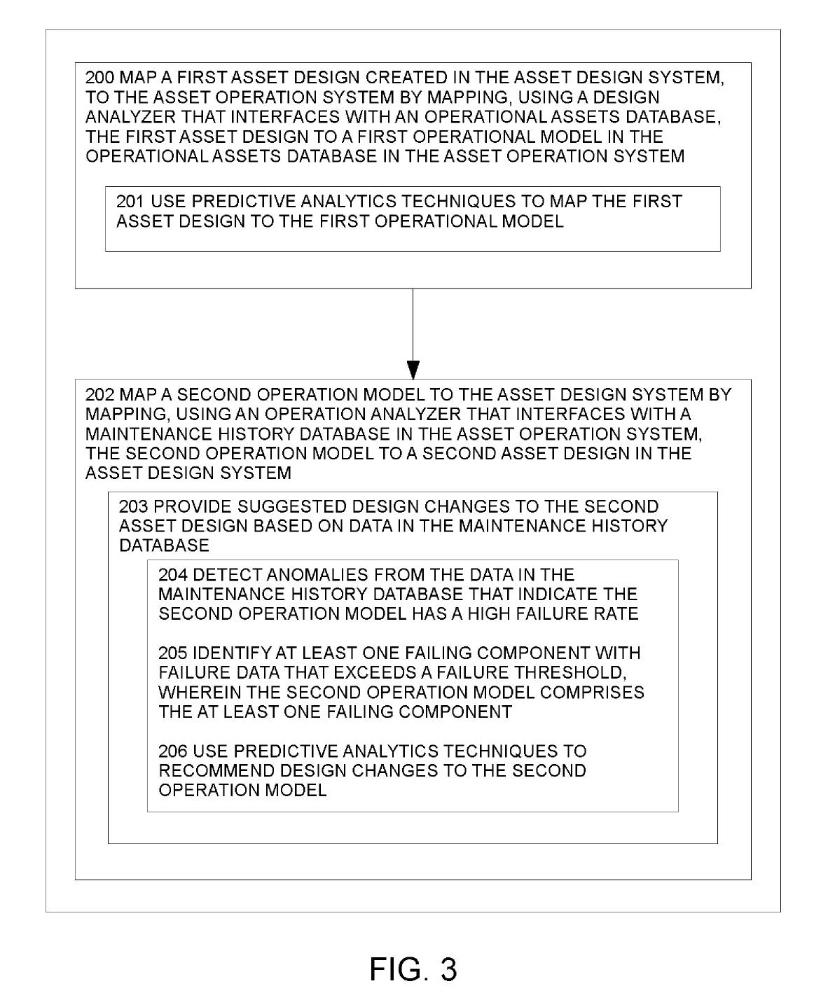

FIG. 3 illustrates an embodiment of a method for integrating an asset design system with an asset operation system. At 200, the method maps a first asset design created in the asset design system, to the asset operation system. The method, using a design analyzer that interfaces with an operational assets database, maps the first asset design to a first operational model in the operational assets database in the asset operation system. In an example embodiment, the mapping determines which component design (in the asset design system) is related to which physical component in an asset operation system. Once mapped, any changes in the asset design may be reflected in the physical component. In other words, once mapped there now exist a direct mapping from design changes to operational data and operational changes. Changes performed by a design team are now automatically reflected in existent operations, and the operations team is notified of those design changes. In an example embodiment, an engineer designer may use an IoT Design Tool (in the asset design system) to create an asset design, for example, an airplane turbine. The asset designs in the asset designs database are used by the design analyzer to map the newly created asset design to a new suggested operational asset. Thus, a newly designed asset/component/subcomponent/etc. is automatically mapped to the asset operation system. In another example embodiment, the design analyzer may use information associated with other operational assets in the operational assets database for asset designs that have yet to be mapped to operational models in the operational assets database. In an example embodiment, an operational model that has been mapped to an asset design maintains a design object key that links back to the asset design. In one example scenario, newly suggested operational assets are presented in an IoT Operational Management Tool (in the asset operation system) to an IoT Asset Administrator for approval and creation of the newly suggested operational assets in the operational assets database. Thus, with the mapping, any modification to the asset design can be reflected in the physical component that is represented by the operational model. The changes made by the design team are automatically reflected in existent operations.

In an example embodiment, when the method uses the design analyzer, at 201, the design analyzer uses predictive analytics techniques to map the first asset design to the first operational model. For example, the design analyzer may use any type of recommendation algorithms, machine learning algorithms, and/or predictive analytics, such as k-Nearest Neighbor (kNN).

In an example embodiment, when the method uses the design analyzer, the design analyzer analyzes an asset designs database to identify asset designs that are similar to the first asset design. For example, an airplane turbine design is created in the IoT Asset Design Tool with all of its components and subcomponents also detailed. Within the IoT Asset Design Tool, the airplane turbine design (i.e., the first asset design) has many components associated with the design, and those components may have subcomponents. The design analyzer executes an analytical algorithm that searches for all designs in the asset designs database that are similar to the airplane turbine design. In an example embodiment, “similar” may be, for example, that 85% of the subcomponents of similar designs match the subcomponents of the airplane turbine design. The percentage of components that are required to match to meet the “similar” threshold may be determined by a user, and/or may be automatically determined by the method.

In an example embodiment, the design analyzer ranks the identified asset designs to determine preferred asset designs. As noted above, the design analyzer identifies asset designs that are similar to the first asset design. The asset designs identified as being “similar” are ranked, and the top ranked designs are designated as the preferred asset designs. The design analyzer then determines whether there are asset models in the operational assets database that match the preferred asset designs.

In an example embodiment, the design analyzer identifies asset models in the operational assets database that match the preferred asset designs, and proposes reusing at least one of the asset models to create the first operational model by modifying at least one of the asset models to match the first asset design. In other words, if the design analyzer identifies asset models that match the preferred asset design, the design analyzers proposes reusing the asset models for the first asset design. Alternatively, one or more of the chosen asset models may be modified to match the first asset design. The method then creates the first operational model from the reused/modified asset model(s). Once created, the method stores the first operational model in the operational assets database with a design object key linking the first operational model to the first asset design.

In an example embodiment, the design analyzer may fail to identify asset models in the operational assets database that match the preferred asset designs. In this example scenario, the design analyzer analyzes model templates in a model templates database in the asset operation system that match the preferred asset designs. The model templates are used to create operational models. In an example embodiment, the design analyzer proposes using at least one of the model templates to create the first operational model. The method then creates the first operational model from one of the model templates, and stores the first operational model in the operational assets database with a design object key linking the first operational model to the first asset design.

In an example embodiment, when the design analyzer analyzes the asset designs database to identify asset designs that are similar to the first asset design, the design analyzer analyzes components associated with each of the asset designs. Each of the asset designs is comprised of a respective plurality of components. The complex asset designs generally have a hierarchy of many components and subcomponents. The design analyzer identifies asset designs where the respective plurality of components meets a similarity threshold with first asset design components. The first asset design is comprised of the first asset design components. For example, an airplane turbine design (i.e., the first asset design) has many components (i.e., first asset design components) associated with the design. The design analyzer executes an analytical algorithm that searches for all designs in the asset designs database that are similar to the airplane turbine design. In an example embodiment, “similar” may be, for example, that 85% of the components and/or subcomponents of similar designs match the components and/or subcomponents of the airplane turbine design.

At 202, the method maps a second operation model to the asset design system (i.e., a reverse integration). The method, using an operation analyzer that interfaces with a maintenance history database in the asset operation system, maps the second operation model to a second asset design in the asset design system. At 203, the operation analyzer provides suggested design changes to the second asset design based on data in the maintenance history database. Thus, as an asset/operation model/component/subcomponent/etc. is fixed and/or modified during the maintenance and operation of the asset during the lifecycle of the asset in the asset operation system, the asset is automatically updated in the asset design system, for example, within the IoT Asset Design Tool. Changes made in the asset operation system may be used to improve designs.

In an example embodiment, when the operation analyzer provides suggested design changes to the second asset design based on the data in the maintenance history database, at 204 the operation analyzer detects anomalies from the data in the maintenance history database that indicate the second operation model has a high failure rate. In an example embodiment, an analytical algorithm is periodically executed on data in the maintenance history database to detect anomalies that may warrant design changes. Over the lifecycles of assets, data is collected related to the functioning of the assets, and the maintenance performed on the assets. This data is maintained, for example, in the maintenance history database in the asset operation system.

In an example embodiment, at 205, the operation analyzer identifies at least one failing component with failure data that exceeds a failure threshold, where the second operation model comprises the failing component. For example, after continuous operation of an airplane turbine (i.e., the second operation model), the operation analyzer, executing an analytical algorithm, identifies that the turbine engine's starter generator (i.e., the failing component) requires replacement in 80% of the flights longer than 10 hours.

In an example embodiment, at 206, the operation analyzer uses predictive analytics techniques to recommend design changes to the second operation model. For example, the operation analyzer uses a predictive analytics technique, such as k-Nearest Neighbor (kNN) to recommend design changes. The operation analyzer may use any type of recommendation algorithms, machine learning algorithms, and/or predictive analytics. Using the predictive analytics, the operation analyzer identifies other operation models/components/subcomponents/etc. that may be used to replace and/or modify, for example, the turbine engine's starter generator (i.e., the failing component). In other words, the operation analyzer identifies parts that have an unacceptable failure rate, and analyzes thousands and thousands of complex parts to identify replacement parts, and/or modifications to existing parts to reduce the failure rate.

In an example embodiment, the operation analyzer uses predictive analytics techniques to determine whether a component change (associated with the second operation model) is a change that needs to be reflected within the asset design. The operation analyzer may identify a better component design, or a replacement component design for the component that the operation analyzer has determined exceeds the failure threshold. In an example embodiment, the design analyzer examines data in the maintenance history database to identify components and/or subcomponents that have a similar design to, for example, the starter generator of the turbine engine. The design analyzer also examines data in the maintenance history database to identify component and/or subcomponents that have a satisfactory maintenance history. In this example scenario, based on the design and operation of other starter generators, the operation analyzer may recommend design changes for the turbine engine, such as changes to the starter generator design and/or using another subcomponent. In an example embodiment, the method may present this suggested change to a design engineer for approval. Upon approval, the change is automatically made to the design of the turbine engine so that the turbine engine can support longer flights with an improved operation history.

In an example embodiment, when the operation analyzer uses predictive analytics techniques to recommend design changes to the second operation model, the operation analyzer identifies, from the maintenance history database, at least one component that at least meets a low failure threshold (i.e., the component has a low failure rate), where the component is similar to at least one failing component. In one example embodiment, the operation analyzer may recommend use of at least one component in the second operation model to reduce the high failure rate associated with the second operation model. In another example embodiment, the operation analyzer may recommend modification of the failing component using the component as a prototype, to reduce the high failure rate associated with the second operation model. In an example scenario, the operation analyzer identifies the turbine engine has a component with a high failure rate (i.e., the starter generator). The operation analyzer identifies, from the maintenance history database, a similar component (or similar subcomponent if there's a subcomponent of the starter generator that can be swapped out to reduce the starter generator's failure rate) with a low failure rate. The operation analyzer may recommend replacing the starter generator with the similar component, or may recommend changes to the starter generator using the similar component as a prototype.

In an example embodiment, when the operation analyzer uses predictive analytics techniques to recommend design changes to the second operation model, the method may automatically implement the design changes. Alternatively, the method may transmit the recommended design changes to a user, and automatically implement the recommended design changes upon approval from the user. For example, the design object key may be used to refer back to the asset design in the asset design database, and propose the recommended design change to an Engineer Designer via the IoT Design Tool.

In an example embodiment, when the operation analyzer uses predictive analytics techniques to recommend design changes to the second operation model, the method obtains, from the operational assets database, a design object key associated with the second operation model. The method uses the design object key associated with the second operation model to locate the second asset design in the asset design system, and implements the recommended design change for the second asset design in the asset design system.

In an example embodiment, the operation analyzer detects asset designs that have a high failure rate, and may recommend changes to those assets. Using the predictive analytics, the operation analyzer may identify assets/components/subcomponents that are similar to the failing asset design for the purpose of identifying those similar asset designs as failing asset designs. In this example scenario, the operation analyzer may recommend changes even before enough data has been captured in the maintenance history database to identify the similar failing asset designs. The operation analyzer may also recommend updated maintenance scheduling (such as replacing a part before the maintenance data predicts failure, or in anticipation of failure based on the maintenance data for other similar assets) for the similar failing assets/components/subcomponents.

The descriptions of the various embodiments of the present invention have been presented for purposes of illustration, but are not intended to be exhaustive or limited to the—embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of integrating an asset design system with an asset operation system, the method comprising:
mapping a first asset design created in the asset design system, to the asset operation system by mapping, using a design analyzer that interfaces with an operational assets database, the first asset design to a first operational model in the operational assets database in the asset operation system.

2. The method of claim 1 wherein using the design analyzer comprises:
using predictive analytics techniques to map the first asset design to the first operational model.

3. The method of claim 1 wherein using the design analyzer comprises:
analyzing, by the design analyzer, an asset designs database to identify asset designs that are similar to the first asset design;
ranking the identified asset designs to determine preferred asset designs; and
determining whether there are asset models in the operational assets database that match the preferred asset designs.

4. The method of claim 3 further comprising:
identifying asset models in the operational assets database that match the preferred asset designs;
proposing, by the design analyzer, reusing at least one of the asset models to create the first operational model by modifying the at least one of the asset models to match the first asset design;
creating the first operational model from the modified at least one of the asset models; and
storing the first operational model in the operational assets database with a design object key linking the first operational model to the first asset design.

5. The method of claim 3 further comprising:
failing to identify asset models in the operational assets database that match the preferred asset designs;
analyzing, by the design analyzer, model templates in a model templates database in the asset operation system that match the preferred asset designs, wherein the model templates are used to create operational models;
proposing, by the design analyzer, using at least one of the model templates to create the first operational model; and
creating the first operational model from the at least one of the model templates; and
storing the first operational model in the operational assets database with a design object key linking the first operational model to the first asset design.

6. The method of claim 3 wherein analyzing, by the design analyzer, the asset designs database to identify asset designs that are similar to the first asset design comprises:
analyzing components associated with each of the asset designs wherein each of the asset designs is comprised of a respective plurality of components; and
identifying asset designs where the respective plurality of components meets a similarity threshold with first asset design components, wherein the first asset design is comprised of the first asset design components.

7. The method of claim 1 further comprising:
mapping a second operation model to the asset design system by mapping, using an operation analyzer that interfaces with a maintenance history database in the asset operation system, the second operation model to a second asset design in the asset design system.

8. The method of claim 7 further comprising:
providing suggested design changes to the second asset design based on data in the maintenance history database.

9. The method of claim 8 wherein providing suggested design changes to the second asset design based on the data in the maintenance history database comprises:
detecting anomalies from the data in the maintenance history database that indicate the second operation model has a high failure rate;
identifying at least one failing component with failure data that exceeds a failure threshold, wherein the second operation model comprises the at least one failing component; and
using predictive analytics techniques to recommend design changes to the second operation model.

10. The method of claim 9 wherein using predictive analytics techniques to recommend design changes to the second operation model comprises:
identifying, from the maintenance history database, at least one component that at least meets a low failure threshold, wherein the at least one component is similar to the at least one failing component; and
recommending at least one of:
(i) use of the at least one component in the second operation model to reduce the high failure rate associated with the second operation model; and
(ii) modification of the at least one failing component using the at least one component as a prototype, to reduce the high failure rate associated with the second operation model.

11. The method of claim 9 wherein using predictive analytics techniques to recommend design changes to the second operation model comprises:
at least one of:
(i) automatically implementing the recommended design changes; and
(ii) transmitting the recommended design changes to a user, and automatically implementing the recommended design changes upon approval from the user.

12. The method of claim 9 wherein using predictive analytics techniques to recommend design changes to the second operation model comprises:
obtaining, from the operational assets database, a design object key associated with the second operation model;
using the design object key associated with the second operation model to locate the second asset design in the asset design system; and
implementing the recommended design change for the second asset design in the asset design system.

13. The method of claim 9 wherein using predictive analytics techniques to recommend design changes to the second operation model comprises:
identifying a third asset design as similar to the second asset design;
based on the data in the maintenance history database associated with the second asset design, recommending at least one of (i) design changes and (ii) maintenance scheduling changes to the third asset to preempt at least one failure of the third asset design.

14. A computer program product for integrating an asset design system with an asset operation system, the computer program product comprising:
a computer readable storage medium having computer readable program code embodied therewith, the program code executable by a computer processor to:
map a first asset design created in the asset design system, to the asset operation system by mapping, using a design analyzer that interfaces with an operational assets database, the first asset design to a first operational model in the operational assets database in the asset operation system.

15. The computer program product of claim 14 wherein the computer readable program code configured to use the design analyzer is further configured to:
use predictive analytics techniques to map the first asset design to the first operational model.

16. The computer program product of claim 14 further configured to:
map a second operation model to the asset design system by mapping, using an operation analyzer that interfaces with a maintenance history database in the asset operation system, the second operation model to a second asset design in the asset design system.

17. The computer program product of claim 16 further configured to:
provide suggested design changes to the second asset design based on data in the maintenance history database.

18. The computer program product of claim 17 wherein the computer readable program code configured to provide suggested design changes to the second asset design based on the data in the maintenance history database is further configured to:
detect anomalies from the data in the maintenance history database that indicate the second operation model has a high failure rate;
identify at least one failing component with failure data that exceeds a failure threshold, wherein the second operation model comprises the at least one failing component; and
use predictive analytics techniques to recommend design changes to the second operation model.

19. A system comprising:
a computing processor; and
a computer readable storage medium operationally coupled to the processor, the computer readable storage medium having computer readable program code embodied therewith to be executed by the computing processor, the computer readable program code configured:
map a first asset design created in the asset design system, to the asset operation system by mapping, using a design analyzer that interfaces with an operational assets database, the first asset design to a first operational model in the operational assets database in the asset operation system.

20. The system of claim 18 further configured to:
map a second operation model to the asset design system by mapping, using an operation analyzer that interfaces with a maintenance history database in the asset operation system, the second operation model to a second asset design in the asset design system.
